(19) United States
(12) Patent Application Publication
(10) Pub. No.: US 2007/0263817 A1
(43) Pub. Date: Nov. 15, 2007

(54) Automated intelligent network service configuration

(76) Inventors: Simon Xu Chen, Qing Dao (CN); Alex Zhi Gang Hu, Qingdao (CN); Forest Sen Lin, Qingdao (CN); Edward Chen Zang, Weifang (CN)

Correspondence Address: CARLSON, GASKEY & OLDS, P.C., 400 W MAPLE RD, SUITE 350, BIRMINGHAM, MI, 48009, US

(21) Appl. No.: 11/412,621

(22) Filed: Apr. 27, 2006

(51) Int. Cl. H04M 3/42

(52) U.S. Cl. 379/201.01

(57) ABSTRACT

An intelligent network (20) provides an ability for a user (22) to customize the use of intelligent network services in an automated fashion. A service control point (32) controls operation of the intelligent network services and automatically controls how a service switch point (28) or a home location register (74) maintains a database (72) containing trigger detection point criteria that indicates when an intelligent network service should be provided. In a disclosed example, a user can use a telephone (21) or a mobile station (22) for interfacing with the service control point (32) to set up, modify or cancel an intelligent network service.

### FIELD OF THE INVENTION

This invention generally relates to communications. More particularly, this invention relates to intelligent network communication services.

### DESCRIPTION OF THE RELATED ART

Line-based and wireless communications are used in a variety of situations. Most systems allow for voice communications. More recently, enhanced services and other capabilities have been proposed and introduced. One attempt at expanding the possible services is to utilize an intelligent network. More services become possible when using an intelligent network. Example services include call forwarding, voice activated calling and call screening. Other services become possible through an intelligent network.

One difficulty associated with providing such enhanced services is that it requires manual intervention by an appropriate technician of a telecommunication company to set up, change or deactivate such a service. A technician typically has to manually interact with a service switch point (SSP) through a human-machine interface in order to set up appropriate criteria to realize a desired intelligent network service on behalf of a user.

Not only are there shortcomings associated with the requirement of manual intervention, but different services or different users may require different trigger criterion at different trigger detection points. This presents complications for technicians to create or maintain appropriate data on corresponding service switch points. Additionally, the user has limited freedom on how to utilize the capabilities of an intelligent network.

There is a need for better use of intelligent networks. This invention addresses that need while avoiding the shortcomings mentioned above.

### SUMMARY OF THE INVENTION

An exemplary method of communicating includes automatically configuring a trigger detection point criteria for an intelligent network service pursuant to at least one signal from a user regarding at least one feature of the intelligent network service.

In a disclosed example, the user effectively communicates directly with a service control point that automatically configures the intelligent network service according to the desires of the user. In one example, the service control point automatically initiates an intelligent network service responsive to a request from the user. In another example, the service control point automatically sets at least one parameter of an intelligent network service according to the desires of a user. In another example, the service control point automatically turns off an intelligent network service that had been previously requested.

By automatically interfacing between a service control point and a user, a user is able to much more easily and with greater freedom select which intelligent network services to use and how and when to use them.

An exemplary intelligent network designed according to an embodiment of this invention includes a service control point that communicates with at least one of a service switch point or a home location register and automatically configures a trigger detection criteria for an intelligent network service responsive to a signal from the user.

In one example, the service switch point or the home location register maintains a database containing trigger detection criteria for intelligent network services. The service control point automatically dictates the contents of that database to automatically control how intelligent network services are provided for a user.

The various features and advantages of this invention will become apparent to those skilled in the art from the following detailed description. The drawings that accompany the detailed description can be briefly described as follows.

### BRIEF DESCRIPTION OF THE DRAWINGS

FIGS. 1A and 1B schematically illustrate selected portions of intelligent networks designed according to an embodiment of this invention.

FIG. 2 schematically illustrates an example process useful with an embodiment of this invention.

FIG. 3 schematically illustrates another example process useful with an embodiment of this invention.

### DETAILED DESCRIPTION

The following example intelligent network arrangement allows a user to communicate with a service control point for automatically configuring a desired use of an intelligent network service. An example service control point dynamically configures a trigger detection point criteria that is used for providing an intelligent network service as requested by a user.

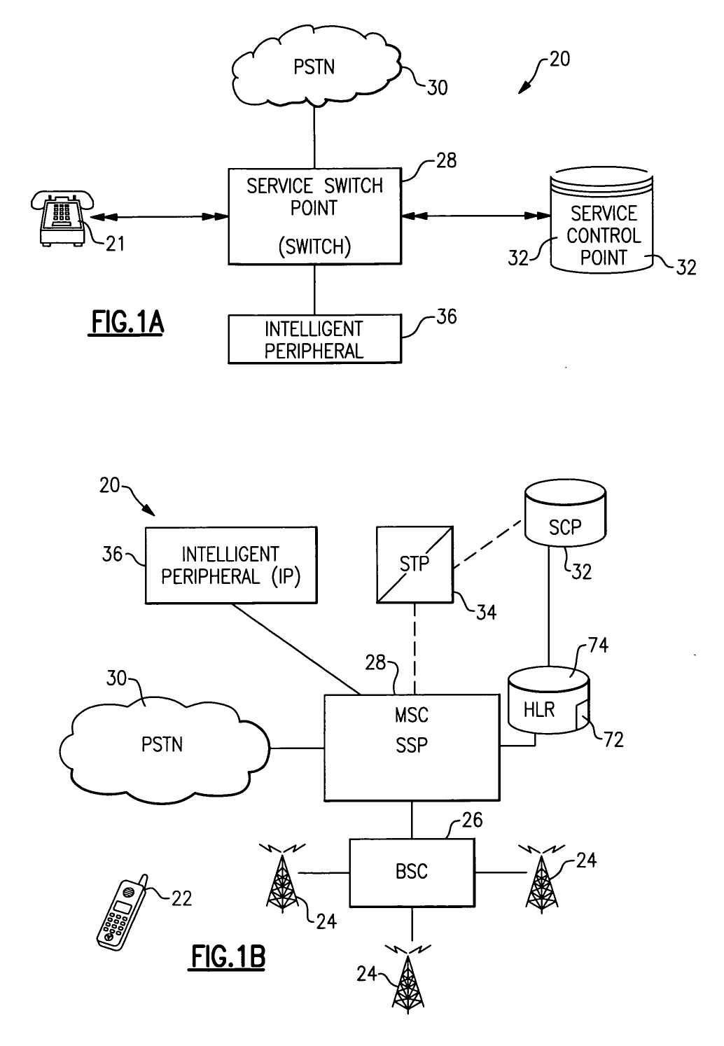

FIG. 1A schematically shows selected portions of an intelligent network 20. In this example, a customer uses a traditional telephone 21 and line-based communication network elements. In the illustrated example, a service switch point (SSP) 28 facilitates communications between the customer using the telephone 21 and a public switch network 30, for example.

The example of FIG. 1A also provides intelligent network services for the customer using the telephone 21. A service control point (SCP) 32 facilitates intelligent network services in a manner to be described below.

FIG. 1B schematically shows selected portions of another use for the intelligent network 20. In this example, a user uses a mobile station 22 to communicate with one or more base stations 24. A base station controller 26 communicates with a mobile switching center (MSC) 28 in a known manner. The mobile switching center 28 in this example is a service switch point (SSP) of the intelligent network and will be referred to as the SSP 28. For example, the SSP 28 facilitates communications between the user using the mobile station 22 and device through a public switched telephone network (PSTN) 30.

The example of FIG. 1B also provides intelligent network services for the user using the mobile station 22. One example intelligent network service that will be discussed for purposes of illustration is flexible call forwarding, which allows the user owning the mobile station 22 to selectively have calls directed to that mobile station forwarded to another number whether it is another mobile station or a line-based telephone. In this example, the user is able to customize that service by selecting a number to which such calls should be forwarded and selecting when the call forwarding feature will be active, for example.

The illustrated examples include a service control point 32 that controls operation of the intelligent network services. The SCP 32 uses known techniques for configuring how an intelligent network service will be carried out and what the trigger detection point criteria will be for recognizing when such a service should be utilized. The SSP 28 and the SCP 32 may comprise hardware, software or both.

In the example of FIG. 1B, a signal transfer point (STP) 34 handles distribution of control signals between the SSP 28 and the SCP 32, for example. In one example, the STP 34 comprises a packet switch in the signaling network that provides the advantage of concentrating link traffic. In one example, the STP 34 also provides address capabilities such as global title translation and gateway screening using known techniques.

The illustrated examples 1 also include an intelligent peripheral device 36 that is useful for some intelligent network services. For example, the intelligent peripheral device 36 has the capability of recognizing a voice signal from a user and converting that into appropriate data that is useful within the network 20 for providing an intelligent network service such as voice activated calling.

When the user using the telephone 21 or the mobile station 22 desires to utilize call forwarding for any calls directed to the telephone 21 or the mobile station 22, the user provides an indication of that by sending at least one signal from the telephone 21 or the mobile station 22, for example.

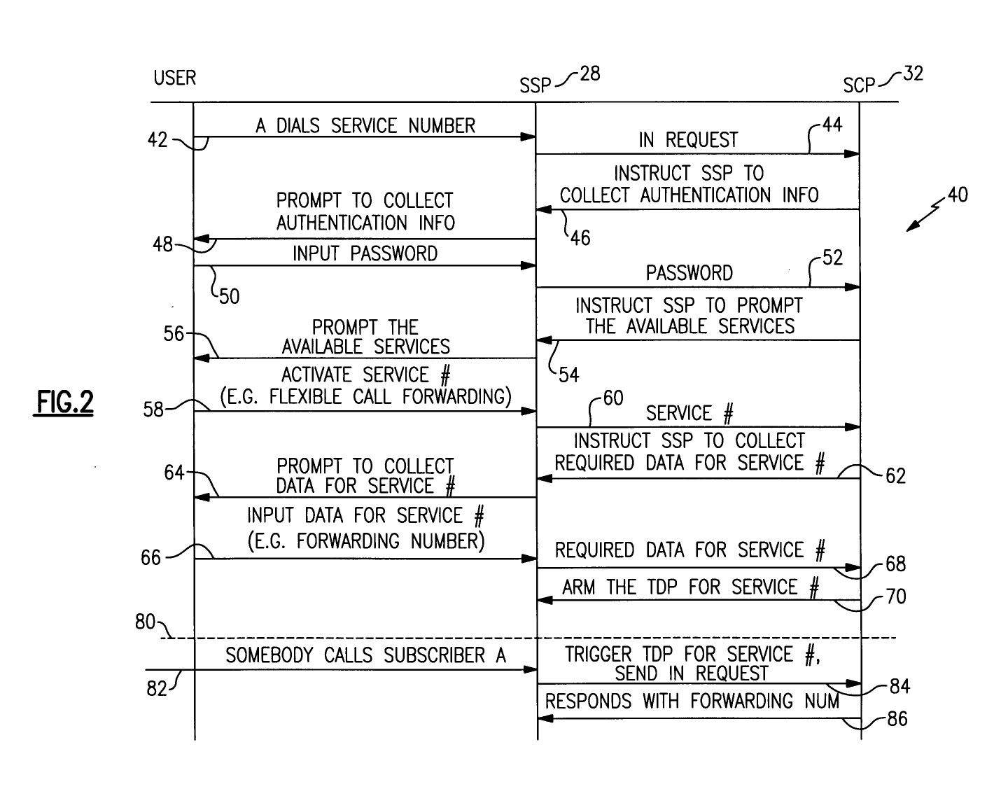

An example process for setting up or instigating a call forwarding service is schematically shown at 40 in FIG. 2. At 42, the user dials in a service number such as an access code number that is recognized by the SSP 28 as an indication that the user desires to arrange the intelligent network services provided to that user such as setting up a new service, changing an existing service or cancelling an existing service. At 44, the SSP 28 communicates the intelligent network access request to the SCP 32.

At 46, the SCP 32 provides a prompt to the SSP 28 to collect authentication information from the user. At 48, an appropriate communication to the user from the SSP 28 is shown. In one example, a visual indication on a display of the telephone 21 or the mobile device 22 will prompt the user to enter the authentication information. In another example, an audible prompting requesting the authentication information is provided to the user.

At 50, the user inputs a password, for example. The password information is forwarded at 52 from the SSP 28 to the SCP 32. Upon appropriate authentication, the SCP 32 verifies that the user has the ability to access intelligent network services and sends a prompt at 54 to the SSP 28 requesting information regarding what service or services the user desires to configure. At 56, such an indication is provided to the user using visible or audible signals, for example.

At 58, the user provides an indication of at least one feature of the desired service. In this example, the user desires to activate a call forwarding service to have calls intended for the telephone 21 or the mobile station 22 sent (e.g., forwarded) to another device. This information is forwarded by the SSP 28 to the SCP 32 at 60. At 62, the SCP 32 requests information necessary to set up the desired service. Examples of such information include the number or numbers to which calls should be forwarded and any limitations on the call forwarding such as only specific callers or only specific times of day. At 64, the SSP 28 prompts the user for such information. At 66, the user sends at least one signal to input the appropriate information. Once that information is received at 68 by the SCP 32, it proceeds to automatically configure trigger detection point criteria at 70 and forwards that information to the SSP 28.

Referring to FIG. 1A, the SSP 28 includes a database 72 that includes trigger detection point criteria for various intelligent network services on behalf of a variety of users. A significant advantage to this example embodiment is that the database 72 is automatically populated, updated and maintained by the actions of the SCP 32 responsive to signals provided by the user. No manual intervention is required by telecommunications personnel and the user has the flexibility of periodically initiating, modifying or terminating selected intelligent network services.

In the example of FIG. 1B, the SSP 28 downloads the trigger detection point criteria to a database 72 within a home location register 74, which also maintains information regarding different mobile subscribers or users in a known manner. In one example, each time that the home location register 74 communicates with the SSP 28 it provides information whether a particular mobile subscriber has selected intelligent network services. In one example, the HLR 74 utilizes a flag set within the database 72 as an indication to provide such information to the SSP 28. In other words, the HLR 74 maintains the trigger detection point criteria and communicates with the SSP 28 in a manner to facilitate implementation of an intelligent network service according to the user-set preferences.

The SSP 28 utilizes the trigger detection point criteria in the database 72 for recognizing when an intelligent network service should be utilized. Such a procedure is schematically shown at 80 in FIG. 2. At 82, another caller places a call to the telephone 21, for example. The SSP 28 utilizes the trigger detection point criteria within the database 72 to recognize that an intelligent network service has been requested for such a situation. As schematically shown at 84, the SSP 28 sends an intelligent network request to the SCP 32 indicating that the SSP 28 has detected the trigger detection point criteria associated with service requested previously by the user (e.g., to forward the incoming call to another number). The SCP 32 then takes appropriate action to implement the intelligent network service corresponding to the trigger detection point criteria recognized by the SSP 28. In this example, at 86, the SCP 32 responds by providing the forwarding number indicated by the user to the SSP 28. The SSP 28 can then forward the incoming call to the appropriate number.

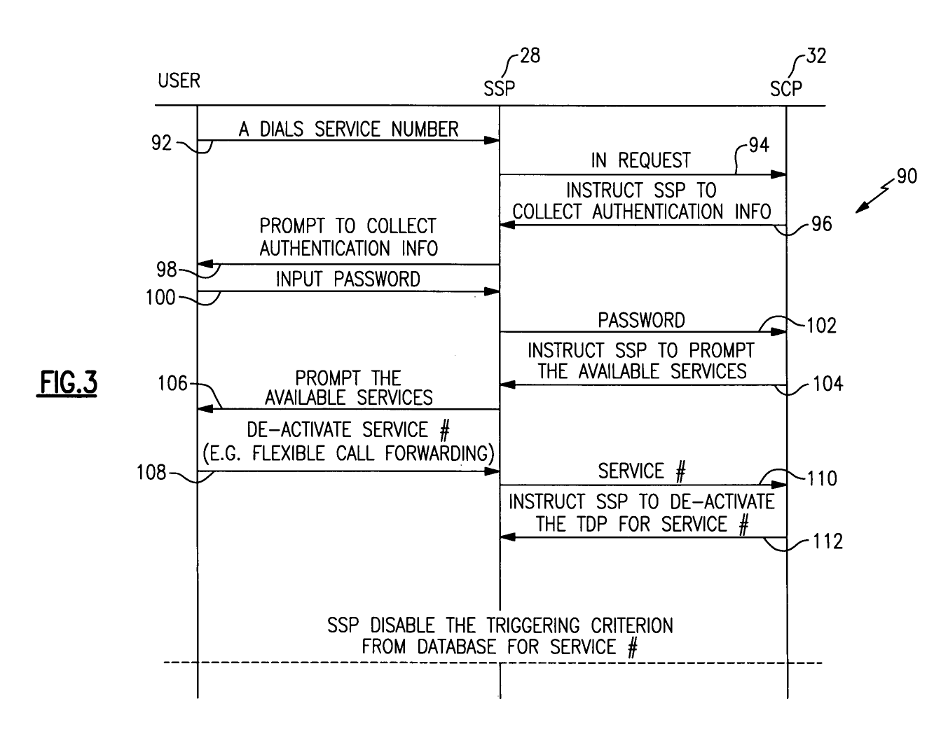

FIG. 3 schematically shows another example process at 90. In this example, the user desires to turn off or deactivate an intelligent network service that the user had previously requested. In this example, the user dials the access code or service number at 92. The SSP 28 recognizes this as a request for accessing or interfacing with the SCP 32 for purposes of configuring an intelligent network service. The request is forwarded at 94 to the SCP 32. At 96, the SCP 32 instructs the SSP 28 to collect appropriate authentication information. At 98, the SSP 28 provides an audible or visual signal to the user requesting authentication information. In this example, the user inputs the password at 100.

Once the SCP 32 receives the password as schematically shown at 102 and authenticates it, the SCP 32 instructs the SSP 28 at 104 to provide appropriate prompts to the user indicating how the user may customize their currently used or available intelligent network services. An appropriate prompting is provided to the user at 106. In this example, the user desires to deactivate a current service such as the call forwarding service set up in the example of FIG. 2. An appropriate communication at 108 from the user through the mobile station 22 is provided to the SSP 28. That information is forwarded at 110 to the SCP 32. Once the information is appropriately processed, the SCP 32 automatically instructs the SSP 28 to deactivate the trigger detection point criteria for the corresponding service. This is shown at 112 in FIG. 3.

In one example, the SSP 28 deactivates the appropriate trigger detection point criteria in the database 72 by erasing corresponding data. In another example, the SSP 28 modifies the entry of the corresponding trigger detection point criteria in the database 72 by setting a flag, for example, so that it is not utilized until a subsequent request (if any), from the user to reactivate the corresponding intelligent network service.

The above examples provide enhanced abilities for a user to selectively use intelligent network services without requiring manual intervention of telecommunication personnel.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of communicating, comprising
dynamically configuring a trigger detection point criteria for an intelligent network service pursuant to at least one signal from a user regarding at least one feature of the intelligent network service.

2. The method of claim 1, comprising
automatically initiating the intelligent network service pursuant to the at least one signal.

3. The method of claim 1, comprising
automatically deactivating the intelligent network service pursuant to the at least one signal.

4. The method of claim 1, comprising
automatically setting at least one parameter associated with the intelligent network service.

5. The method of claim 1, comprising
using a service control point of an intelligent network for automatically configuring the trigger detection point criteria.

6. The method of claim 5, comprising
maintaining a database for the service control point that includes information indicating at least one process corresponding to the intelligent network service; and
maintaining the trigger detection point criteria at one of a service switch point or a home location register that communicates with the service control point when the criteria is met.

7. The method of claim 6, comprising
detecting the trigger detection point criteria at the service switch point;
communicating the detected trigger detection point criteria between the service switch point and the service control point;
determining how to implement the intelligent network service at the service control point; and
implementing the intelligent network service.

8. The method of claim 1, comprising
providing an access code that can be used by the user to instigate a process of automatically configuring the triggering point criteria; and
responding to the user using the access code by prompting the user to provide the at least one signal.

9. The method of claim 1, comprising
authenticating the at least one signal from the user before configuring the trigger detection point criteria for the intelligent network service.

10. The method of claim 9, comprising
receiving the at least one signal from the user;
prompting the user to provide authentication information; and
verifying that received authentication information is proper to thereby authenticate the at least one signal.

11. The method of claim 1, comprising
sending the at least one signal from one of a line-based communication device or a mobile station.

12. The method of claim 11, comprising at least one of
providing an indication to activate the intelligent network service;
providing an indication to deactivate the intelligent network service; or
providing an indication to set a parameter of the intelligent network service.

13. An intelligent network, comprising
a service control point that communicates with at least one of a service switch point or a home location register and dynamically configures a trigger detection criteria for an intelligent network service pursuant to at least one signal from a user.

14. The intelligent network of claim 13, wherein the service control point authenticates the signal from the user before configuring the trigger detection point criteria for the intelligent network service.

15. The intelligent network of claim 12, wherein the service switch point receives the at least one signal from the user and forwards an indication of the at least one signal to the service control point, the service control point responsively instructs the service switch point to prompt the user to provide authentication information and the service control point verifies that received authentication information is proper to thereby authenticate the at least one signal.

16. The intelligent network of claim 13, wherein the service control point automatically performs at least one of
initiating the intelligent network service;
deactivating the intelligent network service; or
setting at least one parameter associated with the intelligent network service.

17. The intelligent network of claim 13, wherein
the service control point comprises a database that includes information indicating at least one process corresponding to the intelligent network service; and
the at least one of the service switch point or the home location register maintains an indication of the trigger detection point criteria and the service control point receives an indication of when the criteria is met.

18. The intelligent network of claim 17, wherein
the service switch point detects the trigger detection point criteria and responsively communicates the detection to the service control point; and
the service control point determines how to implement the intelligent network service and the intelligent network implements the service.

19. The intelligent network of claim 11, wherein at least the service switch point recognizes an access code that can be used by the user to instigate a process of automatically configuring the trigger detection point criteria.

20. The intelligent network of claim 19, wherein
the service control point responds to the user using the access code by requesting the at least one signal.
